(19) United States
(12) Patent Application Publication
(10) Pub. No.: US 2012/0278180 A1
(43) Pub. Date: Nov. 1, 2012

(54) METHODS AND ARRANGEMENTS FOR IMPROVING MONETIZATION OF TELECOM APP-STORES VIA COMBINATORIAL BIDDING ON TELECOM PARAMETERS

(75) Inventors: Vikas Agarwal, New Delhi (IN); Sumit Mittal, Uttar Pradesh (IN); Sougata Mukherjea, New Delhi (IN)

(73) Assignee: INTERNATIONAL BUSINESS MACHINES CORPORATION, Armonk, NY (US)

(21) Appl. No.: 13/097,150

(22) Filed: Apr. 29, 2011

(51) Int. Cl. G06Q 30/00

(52) U.S. Cl. 705/14.71

(57) ABSTRACT

Methods and arrangements for facilitating the promotion of telecom applications. Promotion filter criteria is accepted, and bids on telecom information elements relating to promotion dissemination are accepted. A promotion is associated with a telecom customer based on matchmaking between the promotion and the customer, based on the filter criteria and on the bids on telecom information elements.

### BACKGROUND

New generations of mobile phones, e.g., those compatible with 3G or 4G networks, have lead to explosive growth in applications, or “apps” for those phones. Mobile phone manufacturers now offer application stores, or app stores, where a customer can purchase apps for their phones. App stores, however, are usually distinct from the associated telecoms (or telecom operators), and telecoms have not been able to benefit greatly from this separate arrangement.

### BRIEF SUMMARY

In summary, one aspect of the invention provides a method comprising: accepting promotion filter criteria input; accepting bids on telecom information elements relating to promotion dissemination; and associating a promotion with a telecom customer based on matchmaking between the promotion and the customer, based on the filter criteria and on the bids on telecom information elements.

Another aspect of the invention provides an apparatus comprising: at least one processor; and a computer readable storage medium having computer readable program code embodied therewith and executable by the at least one processor, the computer readable program code comprising: computer readable program code configured to accept promotion filter criteria input; computer readable program code configured to accept bids on telecom information elements relating to promotion dissemination; and computer readable program code configured to associate a promotion with a telecom customer based on matchmaking between the promotion and the customer, based on the filter criteria and on the bids on telecom information elements.

An additional aspect of the invention provides a computer program product comprising: a computer readable storage medium having computer readable program code embodied therewith, the computer readable program code comprising: computer readable program code configured to accept promotion filter criteria; computer readable program code configured to accept bids on telecom information elements relating to promotion dissemination; and computer readable program code configured to associate a promotion with a telecom customer based on matchmaking between the promotion and the customer, based on the filter criteria and on the bids on telecom information elements.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system.

FIG. 2 schematically illustrates an arrangement for facilitating combinatorial bidding on telecom parameters in the promotion of telecom applications.

FIG. 3 sets forth a process more generally for facilitating the promotion of telecom applications.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art will recognize, however, that the various embodiments of the invention can be practiced without at least one of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

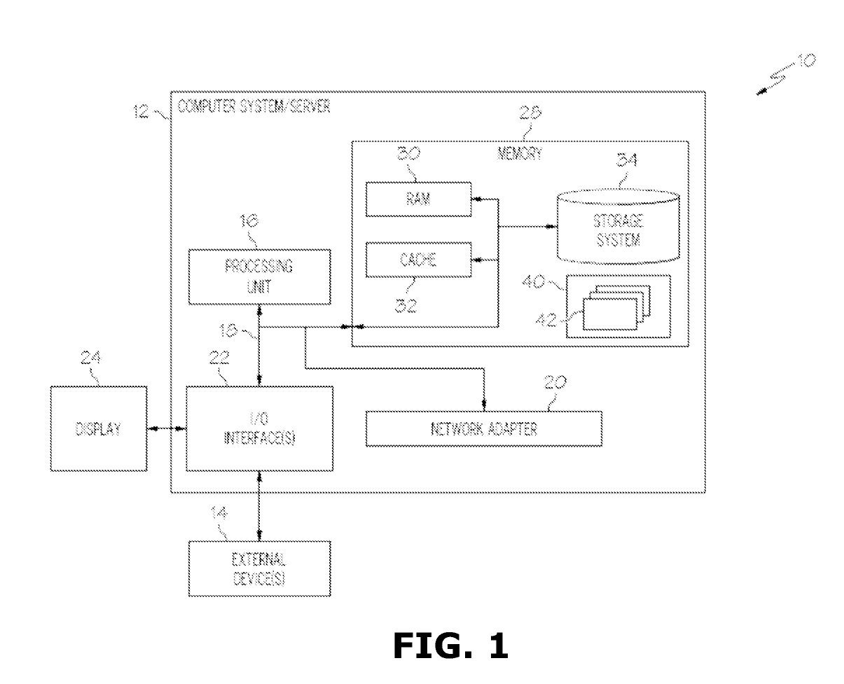

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In accordance with embodiments of the invention, computing node 10 may not necessarily even be part of a cloud network but instead could be part of another type of distributed or other network, or could represent a stand-alone node. For the purposes of discussion and illustration, however, node 10 is variously referred to herein as a “cloud computing node”.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable customer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, at least one processor or processing unit 16, a system memory 28, and a bus 18 that couples various system components including system memory 28 to processor 16.

Bus 18 represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by at least one data media interface. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, at least one application program, other program modules, and program data. Each of the operating system, at least one application program, other program modules, and program data or some combination thereof, may include an implementation of a networking environment. Program modules 42 generally carry out the functions and/or methodologies of embodiments of the invention as described herein.

Computer system/server 12 may also communicate with at least one external device 14 such as a keyboard, a pointing device, a display 24, etc.; at least one device that enable a user to interact with computer system/server 12; and/or any devices (e.g., network card, modem, etc.) that enable computer system/server 12 to communicate with at least one other computing device. Such communication can occur via I/O interfaces 22. Still yet, computer system/server 12 can communicate with at least one network such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

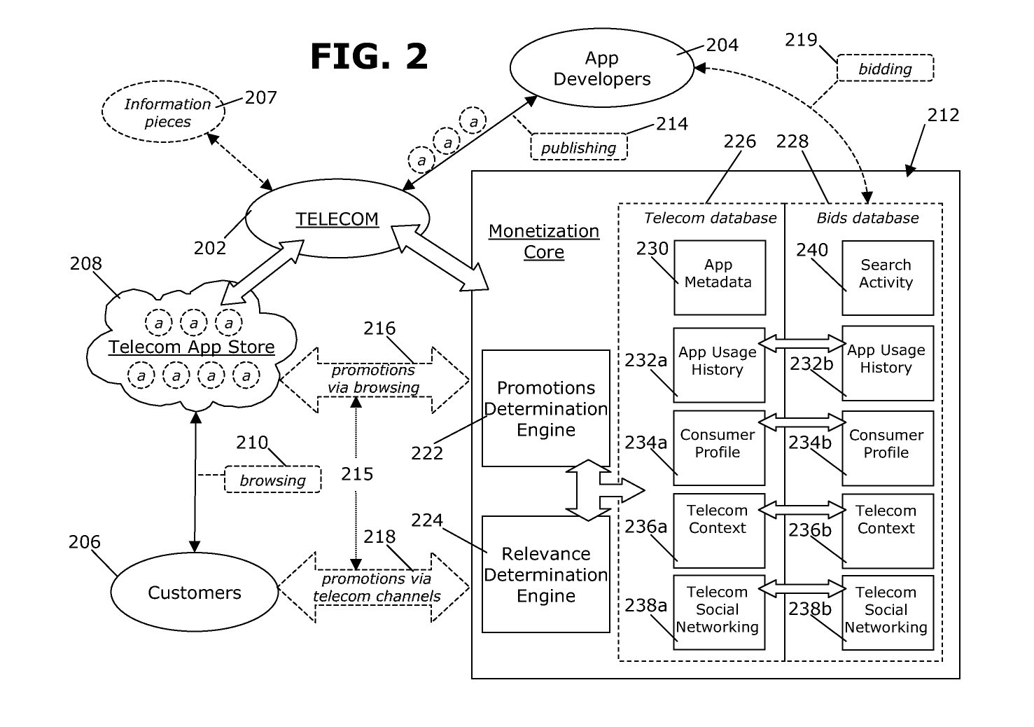

The disclosure now turns to FIG. 2. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12 in FIG. 1. In accordance with an example embodiment, most if not all of the process steps, components and outputs discussed with respect to FIG. 2 can be performed or utilized by way of a processing unit or units and system memory such as those indicated, respectively, at 16 and 28 in FIG. 1, whether on a server computer, a client computer, a node computer in a distributed network, or any combination thereof.

In accordance with at least one embodiment of the invention, it is recognized that a telecom operator, or telecom, has or has access to several information pieces that can be used during a customer's search for apps, and even can be used in the cross-selling, up-selling of various apps. Such information includes, but is not necessarily limited to: keywords, tags, categories and other metadata information attached to an application; telecom real-time context information, e.g., a location defined with high granularity; telecom social networking (e.g. call and SMS texting patterns); static customer profiles; and customer history of app downloading, usage or footfall.

As mentioned above, app developers can, in accordance with at least one embodiment of the invention, be afforded the capability of having their apps highlighted during a search as well as in the context of cross-selling or up-selling. This can be of great assistance in helping distinguish apps from the very large numbers of others that continue to be published on a virtually daily basis. Accordingly, there is broadly contemplated herein the affording of an expanded meeting ground or ecosystem between telecoms, app developers and customers where an app store is monetized via a form of bidding by app developers on different telecom information pieces. (“AppStore” is a trademark of Apple Inc., of Cupertino, Calif., while herein the term “app store” is used generically.)

As shown in the arrangement of FIG. 2, broadly contemplated herein, in accordance with at least one embodiment of the invention, is the use of a telecom 202 as a host or clearinghouse for buying, selling and advertising among participants such as app developers 204 and customers 206. App developers 204 can thus contract with a telecom 202 on how information pieces (207) associated with the telecom 202 will be employed in connection with the developers' apps (a). (These information pieces 207 are shown here conceptually and in general terms but, as will be appreciated herebelow in connection with the discussion of telecom database 226, such information pieces can coincide with information contained in the information blocks 232a/234a/236a/238a to be described.) As shown, a telecom app store 208 is associated with the telecom 202, whereby apps (a) are made available to the customers 206 through customer browsing 210. Also associated with telecom 202 is a monetization core 212, the function of which will be better understood from the discussion herebelow.

Elaborating further, in accordance with at least one embodiment of the invention, app developers 204 create apps (a), and publish them via publishing 214, with the apps (a) then being hosted at the app store 208. Customers (or users) 206 access or download applications hosted at the app-store 208 and in that connection receive promotions 215, whether these are provided directly while browsing (216) or via telecom channels (218). App developers 204 are also afforded the capability of bidding (219), in a manner to be better understood in further discussion herebelow.

Monetization core 212, in accordance with at least one embodiment of the invention, employs a system for promotions determination and relevance determination, via engines 222 and 224, respectively, the functions of both of which will be better understood from further discussion herebelow. Also, within monetization core 212, two databases are provided, namely, a telecom database 226 and a bids database 228. In telecom database, five information blocks (e.g., which themselves can be in the form of smaller databases) include: an app metadata block 230, an app usage history block 232a, a consumer profile block 234a, a telecom context block 236a and a telecom social networking block 238a.

In the context of blocks 230/232a/234a/236a/238a, in accordance with at least one embodiment of the invention, app metadata (230) is provided by the app developer 204 when an app is published (214) to app store 208, and can be modified subsequently. App usage history (232a) can be built by the telecom 202 during the course of app download/purchase by consumers 210. Consumer (or customer) profile information (234a), such as age, gender, occupation, etc., can be captured when a customer 206 first registers with the telecom 202 for being availed of the latter's services, can be updated by the customer 206. Telecom context (236a) can be automatically determined by the telecom 202 (e.g., location can be inferred from the current tower with which a customer 206 is exchanging signals). Telecom social networking information can be built by the telecom 202 based on the usage of its services, such as a number and duration of calls made, and SMS texts sent and received.

In accordance with at least one embodiment of the invention, the app metadata block 230 is used in ascertaining and storing app metadata information, which can include, but certainly need not be limited to, keywords, tags and categories; such metadata is associated with (e.g., resident in) apps that are published (214). The app usage history block 232a is used in ascertaining and storing information on customer app usage history (e.g.,. app downloading, usage or footfall). The consumer profile block 234a provides information about the consumer (e.g., demographics, occupation, interest, consumer rating, etc.). The telecom context block 236a determines customer-related information such as a current location and presence of a customer, while telecom social networking block 238a is used to ascertain and store information relating to how a customer networks, e.g., through call and SMS texting patterns. Telecom social networking block 238a, particularly, can determine patterns such as who calls whom, the duration and frequency of calls, a frequency of SMS texts sent and received, etc.

In accordance with at least one embodiment of the invention, in bids database 228, bids by developers on various information elements are stored for promoting their applications, in a manner to be better understood in further discussion herebelow. Generally, in accordance with at least one embodiment of the invention, the bids database 228 serves to store bids for promoting apps by developers 204, corresponding to information in the telecom database 226. For each information element in the telecom database 226, a developer 204 can put in a bid that then is stored in corresponding blocks of the bids database 228.

In accordance with at least one embodiment of the invention, there is provided in bids database 228 a search activity block 240, which stores the bids on customer searches for various keywords related to apps. There are further included an app usage history block 232b, a consumer profile block 234b, a telecom context block 236b and a telecom social networking block 238b. These four blocks 232b/234b/236b/238b correspond to blocks 232a/234a/236a/238a of telecom database 226 in that the former four blocks will serve to store information regarding which information pieces from the latter four blocks are being bid upon by a developer 204.

In accordance with at least one embodiment of the invention, each information piece available in app store 208 is organized in a manner that facilitates the placing of bids (219) by developers 204. As will be appreciated, this entails non-trivial manners of information representation, assimilation and reasoning. Combinatorial bidding is facilitated, where bids on individual information pieces can be combined to yield a comprehensive transaction. Relevance-driven increase of footfall and monetization (through sale of apps) is traded off with promotion-driven monetization, whereupon the overall revenue of the telecoms 202 is optimized.

Overall, in accordance with at least one embodiment of the invention, bidding (219) by app developers 204 involves specifying parameters, and qualitative or quantitative values associated therewith, via which specific information pieces of a telecom can be isolated in which a developer has particular interest and for which at least one actual bid can be placed, to the extent of using such pieces as vehicles for promoting at least one app of the developer. In accordance with at least one embodiment of the invention, app metadata 230 includes app information such as: tags (that is, keywords that further qualify the content of an app), app category, characteristics of devices with which the app is compatible (e.g., touch screen phone, keypad-based phone, available phone screen resolution, etc.), network requirements, and price range (i.e., a range of prices at which an app will be offered to customers. This information helps in testing the compatibility of apps with different information pieces of the telecom 202, to the extent that such pieces can be used effectively as vehicles for promoting at least one app.

In accordance with at least one embodiment of the invention, bidding (219) parameters include location information desired for promotions. Such location information can include: at least one country, at least one city, at least one area within a city, a center point (latitude and longitude) and/or a neighborhood definition (radius in kilometers). Should a developer 204 wish for short-term presence of a promotion in a location, or a “presence zone”, then the bidding parameters can include location (as defined above) and a specified time period (based on information in block 234a, with bids stored in block 234b).

In accordance with at least one embodiment of the invention, bidding (219) parameters can also include a customer profile, such as age category, gender, occupation category, interests, customer rating and social profile. A customer rating, e.g., gold, silver, platinum, etc., is assigned by telecom 202 operator depending on monthly billing and/or purchase of applications/other services. A social profile can refer to customer usage of social media. Bids on these parameters can be based on information in block 234a and stored in block 234b.

In accordance with at least one embodiment of the invention, bidding (219) parameters can also include telecom social networking parameters, which are used for defining “friends” and to expand advertising/promotions to such friends. Information stored in telecom social networking block 238a can be used for such a purpose (e.g., call and texting graphs, along with information on call durations and frequency or texting frequency), with bids stored in block 238b.

In accordance with at least one embodiment of the invention, bidding (219) parameters can also include app download and purchase history, relating to such information as download/purchase time periods and app metadata; information stored in app usage history block 232a can be used for this purpose and stored in block 232b. Further, search history parameters can be used for finding customers with particular types of search history or keyword use; information stored in the search activity block 240 can be used for this purpose.

In accordance with at least one embodiment of the invention, a bidding (219) methodology involves the selection of filter criteria from among the set of telecom parameters (examples of which parameters are discussed hereinabove). Taking these filter criteria away from the telecom parameters, then, would result in remaining parameters to be used in bidding. In other words, there is a finite set of parameters at the outset, which are then presented to a developer 204, whereupon the developer 204 chooses filter criteria, after which the “bidding” parameters are what remain from that finite set. Bidding parameters can vary for each app promotion or advertisement, and a bid value can be determined for showing a promotion to customers (e.g., having a promotion appear responsive to a customer click). This value can be determined by assigning variable weights to different telecom parameters (after removing filter parameters), and each app developer can bid on at least one parameter.

In a matchmaking process in accordance with at least one embodiment of the invention, app developers 204 publish (214) apps (a) to the telecom 202 and associated app store 208. The developers 204 then place bids (219) on advertising or promoting apps based on different telecom parameters. The telecom 202 determines the best ads based on a tradeoff between bid and relevance through the following steps. First, realtime information of a customer 206 (e.g., location and presence) is determined. Other customer information is then obtained (e.g., customer profile, activity history, social networking). Filter criteria are then applied to find applicable ads/promotions, and a relevance R of each ad or promotion to a customer 206 is determined in the relevance determination engine 224. Thus, R is determined as a function of app metadata, location, presence, profile, social networking information, download history information and search history information. (For this purpose, a telecom 202 can derive a suitable formula as it best sees fit.) R can then be boosted with normalized profit that the telecom 202 would make with sale of the app, to obtain R_{b}. In other words, for each app, the profit that a telecom 202 makes is first determined by a sales (through price of the app and the percentage cut it receives.). Profit values across all apps are then normalized to be in the range of 0 to 1, and this value is then multiplied with R to obtain R_{b}

In a subsequent step, in a matchmaking process in accordance with at least one embodiment of the invention, a score S is computed for each ad based on the bid value and weights, particularly:

S=B*(w₁*ps₁+ . . . +wₙ*psₙ),

where B is the total bid value of the ad, wᵢ is the weight for parameter i and psᵢ is the Boolean indicating whether user satisfies the parameter i. An overall ranking of applicable ads is then computed, based on R_{b} and S for each ad, and an auction-based algorithm is run to find costs for a given number of top-ranked ads or promotions. Ranking can be determined by multiplying R_{b} by S. However, other variations of this algorithm are possible, while essentially any suitable auction-based algorithm may be employed. Possible scenarios for showing ads include: when a user lands on an app store page, when a user searches for an application, the use of other telecom channels (e.g., voice, SMS). Essentially, once matchmaking is complete, the ads can be shown in any way desired.

In a variant matchmaking embodiment in accordance with at least one embodiment of the invention, general advertisements could be embraced. In such a scenario, app metadata and download history information would not be used, and there would be no “boosting” to obtain a quantity to obtain R_{b}.

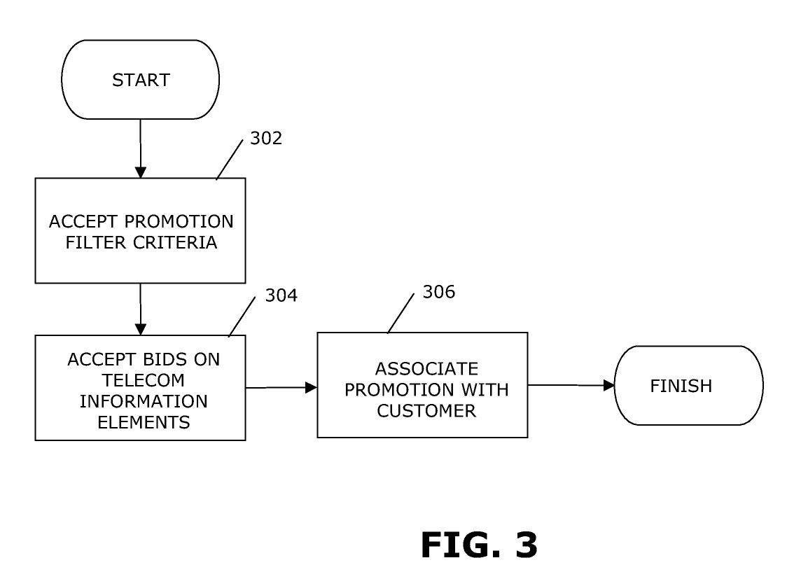

FIG. 3 sets forth a process more generally for facilitating the promotion of telecom applications, in accordance with at least one embodiment of the invention. It should be appreciated that a process such as that broadly illustrated in FIG. 3 can be carried out on essentially any suitable computer system or set of computer systems, which may, by way of an illustrative and on-restrictive example, include a system such as that indicated at 12 in FIG. 1. In accordance with an example embodiment, most if not all of the process steps discussed with respect to FIG. 3 can be performed by way a processing unit or units and system memory such as those indicated, respectively, at 16 and 28 in FIG. 1.

As shown in FIG. 3, promotion filter criteria is accepted (302), and bids on telecom information elements relating to promotion dissemination are accepted (304). A promotion is associated with a telecom customer based on matchmaking between the promotion and the customer, based on the filter criteria and on the bids on telecom information elements (306).

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
accepting promotion filter criteria input;
accepting bids on telecom information elements relating to promotion dissemination; and
associating a promotion with a telecom customer based on matchmaking between the promotion and the customer, based on the filter criteria and on the bids on telecom information elements.

2. The method according to claim 1, wherein the telecom information elements include customer realtime information.

3. The method according to claim 1, wherein the telecom information elements include static customer-related information.

4. The method according to claim 1, wherein the telecom information elements include at least one taken from the group consisting of: metadata information attached to a telecom application; telecom realtime information; telecom social networking patterns; static customer profile information; customer history of downloading a telecom application; customer history of usage of a telecom application; customer history of telecom application footfall; customer search history information.

5. The method according to claim 1, wherein said associating comprises determining a relevance of a promotion to a customer.

6. The method according to claim 5, wherein said associating further comprises calculating a score for associating a promotion with a customer, the score being a function of a bid value of a promotion.

7. The method according to claim 6, wherein said associating further comprises ranking promotions for a customer as a function of the relevance and score.

8. The method according to claim 5, wherein the relevance incorporates an anticipated telecom profit.

9. The method according to claim 1, further comprising providing a structured representation of the telecom information elements available for bidding.

10. The method according to claim 1, wherein said accepting comprises accepting a monetary charge to be borne on promotion of a telecom application, criteria for each telecom information element, and a relative weight assigned to each telecom information element.

11. The method according to claim 1, further comprising delivering a promotion to a customer during at least one taken from the group consisting of: during browsing of a telecom application store; via voice communication; via SMS communication; via web communication.

12. The method according to claim 1, wherein the promotion is associated with a telecom application.

13. An apparatus comprising:
at least one processor; and
a computer readable storage medium having computer readable program code embodied therewith and executable by the at least one processor, the computer readable program code comprising:
computer readable program code configured to accept promotion filter criteria input;
computer readable program code configured to accept bids on telecom information elements relating to promotion dissemination; and
computer readable program code configured to associate a promotion with a telecom customer based on matchmaking between the promotion and the customer, based on the filter criteria and on the bids on telecom information elements.

14. A computer program product comprising:
a computer readable storage medium having computer readable program code embodied therewith, the computer readable program code comprising:
computer readable program code configured to accept promotion filter criteria;
computer readable program code configured to accept bids on telecom information elements relating to promotion dissemination; and
computer readable program code configured to associate a promotion with a telecom customer based on matchmaking between the promotion and the customer, based on the filter criteria and on the bids on telecom information elements.

15. The computer program product according to claim 14, wherein the telecom information elements include customer realtime information.

16. The computer program product according to claim 14, wherein the telecom information elements include static customer-related information.

17. The computer program product according to claim 14, wherein the telecom information elements include at least one taken from the group consisting of: metadata information attached to a telecom application; telecom realtime information; telecom social networking patterns; static customer profile information; customer history of downloading a telecom application; customer history of usage of a telecom application; customer history of telecom application footfall; customer search history information.

18. The computer program product according to claim 14, wherein said computer readable program code is configured to determine a relevance of a promotion to a customer.

19. The computer program product according to claim 18, wherein said computer readable program code is further configured to calculate a score for associating a promotion with a customer, the score being a function of a bid value of a promotion.

20. The computer program product according to claim 19, wherein said computer readable program code is further configured to rank promotions for a customer as a function of the relevance and score.

21. The computer program product according to claim 18, wherein the relevance incorporates an anticipated telecom profit.

22. The computer program product according to claim 14, wherein said computer readable program code is further configured to provide a structured representation of the telecom information elements available for bidding.

23. The computer program product according to claim 14, wherein said computer readable program code is configured to accept a monetary charge to be borne on promotion of a telecom application, criteria for each telecom information element, and a relative weight assigned to each telecom information element.

24. The computer program product according to claim 14, wherein said computer readable program code is further configured to deliver a promotion to a customer during at least one taken from the group consisting of: during browsing of a telecom application store; via voice communication; via SMS communication; via web communication.

25. The computer program product according to claim 14, wherein the promotion is associated with a telecom application.
